(19) United States
(12) Patent Application Publication
(10) Pub. No.: US 2026/0161632 A1
(43) Pub. Date: Jun. 11, 2026

(54) EFFICIENT REMOTE DATA COLLECTION FROM VEHICLE

(71) Applicant: Ford Global Technologies, LLC, Dearborn, MI (US)

(72) Inventors: Serjesh Sharma, Atlanta, GA (US); David Michael Herman, West Bloomfield, MI (US); Sopvan Kishan Rath, Santa Clara, CA (US)

(73) Assignee: Ford Global Technologies, LLC, Dearborn, MI (US)

(21) Appl. No.: 18/974,087

(22) Filed: Dec. 9, 2024

(51) Int. Cl. G06F 16/23

(52) U.S. Cl. CPC G06F 16/2365

(57) ABSTRACT

A computer includes a processor and a memory, and the memory stores instructions executable by the processor to perform a dimensionality reduction on unreduced data to produce reduced data, transmit the reduced data to a server, and, upon receiving an instruction from the server responsive to the reduced data, transmit the unreduced data to the server. The unreduced data is time-series data generated on board a vehicle. The unreduced data has a plurality of unreduced dimensions at each time in a time series. The reduced data has a plurality of reduced dimensions at each time in the time series. The number of reduced dimensions is less than the number of unreduced dimensions. The server is remote from the vehicle.

### BACKGROUND

Modern vehicles often include a plurality of sensors and components that generate data. The sensors can provide data about the operation of the vehicle, for example, wheel speed, wheel orientation, steering angle, steering-wheel angle, steering-column torque, gear shifting, pedal position, and engine and transmission data (e.g., temperature, fuel consumption, etc.). For example, the sensors can include torque sensors, position sensors, temperature sensors, etc. The sensors can detect the location and/or orientation of the vehicle. For example, the sensors can include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors can detect the external world, for example, objects and/or characteristics of surroundings of the vehicle, such as other vehicles, road lane markings, traffic lights and/or signs, road users, etc. For example, the sensors can include radar sensors, scanning laser range finders, light detection and ranging (lidar) devices, and image processing sensors such as cameras. Other components of a vehicle include components of a propulsion system, a steering system, a suspension system, and advanced driver assistance systems (ADAS).

### BRIEF DESCRIPTION OF THE DRAWINGS

FIG. 1 is a diagram of an example communication infrastructure for a fleet of vehicles.

FIG. 2 is a block diagram of an example vehicle of the fleet.

FIG. 3 is a flowchart of an example process for selecting data for transmission from the vehicle to a server of the communication infrastructure.

### DETAILED DESCRIPTION

The task of capturing data generated on board vehicles faces specific challenges. Given the number of sensors and components on board a modern vehicle, the quantity of data generated is quite large. On the other hand, the bandwidth for transmitting data away from a vehicle is often tightly constrained because the transmission is generally wireless. Moreover, because vehicles are necessarily mobile, the amount of bandwidth can fluctuate unpredictably over time as the vehicle moves through different types of networks.

The system described herein provides a resource-efficient way to capture vehicle data. A computer on board the vehicle is programmed to perform a dimensionality reduction on unreduced data to produce reduced data. The term “unreduced data” is used to refer to data generated on board the vehicle before being subjected to the dimensionality reduction, and the term “reduced data” is used to refer to the output of the dimensionality reduction. The unreduced data is time-series data that has a plurality of dimensions at each time in a time series (which will be referred to as “unreduced dimensions”). The reduced data also has a plurality of dimensions at each time in the time series (which will be referred to as “reduced dimensions”). As a result of the dimensionality reduction, the number of reduced dimensions is less than the number of unreduced dimensions. The computer is further programmed to transmit the reduced data to a server that is remote from the vehicle and, upon receiving an instruction from the server responsive to the reduced data, transmit the unreduced data to the server.

The use of dimensionality reduction reduces the quantity of data to be transmitted off board the vehicle to the server. Moreover, the dimensionality reduction provides some advantages compared to, for example, sampling the unreduced data over time or sampling a subset of the unreduced dimensions. The reduced data produced by the dimensionality reduction can provide a more comprehensive measure of what the vehicle is experiencing, which can permit the selection of more relevant unreduced data. As opposed to sampling over time, the reduced data can provide a more fine-grained measure of changes over time. As opposed to sampling a subset of dimensions, the reduced data can incorporate the contributions of all the unreduced dimensions rather than only some, while still significantly reducing the quantity of data. The use of the condition can determine when the data is most likely to be of interest to the server.

A computer includes a processor and a memory, and the memory stores instructions executable by the processor to perform a dimensionality reduction on unreduced data to produce reduced data, transmit the reduced data to a server, and, upon receiving an instruction from the server responsive to the reduced data, transmit the unreduced data to the server. The unreduced data is time-series data generated on board a vehicle. The unreduced data has a plurality of unreduced dimensions at each time in a time series. The reduced data has a plurality of reduced dimensions at each time in the time series. The number of reduced dimensions is less than the number of unreduced dimensions. The server is remote from the vehicle.

In an example, the instructions may further include instructions to, in response to not receiving the instruction from the server responsive to the reduced data within a time limit, refrain from transmitting the unreduced data to the server.

In an example, the reduced dimensions may be respective functions of multiple of the unreduced dimensions.

In an example, the reduced dimensions may be a latent-space representation derived from the unreduced dimensions.

In an example, transmitting the unreduced data to the server may be dependent on a condition on board the vehicle being satisfied. In a further example, the instructions may further include instructions to, in response to the condition being satisfied and the vehicle not being in range of a Wi-Fi network, transmit the unreduced data to the server via a cellular network. In a still further example, the condition may be a first condition, and the instructions may further include instructions to, in response to a second condition on board the vehicle being satisfied, transmit the unreduced data to the server via the Wi-Fi network once the vehicle is in range of the Wi-Fi network. In a yet still further example, the instructions may further include instructions to, in response to the first condition not being satisfied and the second condition not being satisfied, delete the unreduced data.

In another still further example, the condition may be a first condition, and the instructions may further include instructions to, in response to a second condition being satisfied and a buffer having capacity for the unreduced data, store the unreduced data in the buffer. In a yet still further example, the instructions may further include instructions to, in response to a second condition being satisfied and the buffer lacking capacity for the unreduced data, overwrite the buffer with the unreduced data in response to the reduced data satisfying an overwriting condition. In a continued example, the overwriting condition may be that a metric calculated from the reduced data exceeds the metric calculated from data in the buffer.

In another further example, the instructions may further include instructions to receive the condition from the server.

In an example, at least a portion of the unreduced data may be generated by sensors of the vehicle.

In an example, the vehicle may include the computer.

A method includes performing a dimensionality reduction on unreduced data to produce reduced data, transmitting the reduced data to a server, and, upon receiving an instruction from the server responsive to the reduced data, transmitting the unreduced data to the server. The unreduced data is time-series data generated on board a vehicle. The unreduced data has a plurality of unreduced dimensions at each time in a time series. The reduced data has a plurality of reduced dimensions at each time in the time series. The number of reduced dimensions is less than the number of unreduced dimensions. The server is remote from the vehicle.

In an example, the reduced dimensions may be respective functions of multiple of the unreduced dimensions.

In an example, transmitting the unreduced data to the server may be dependent on a condition on board the vehicle being satisfied. In a further example, the method may further include, in response to the condition being satisfied and the vehicle not being in range of a Wi-Fi network, transmitting the unreduced data to the server via a cellular network. In a still further example, the condition may be a first condition, and the method may further include, in response to a second condition being satisfied, transmitting the unreduced data to the server via the Wi-Fi network once the vehicle is in range of the Wi-Fi network.

In another still further example, the condition may be a first condition, the method may further include, in response to a second condition being satisfied and a buffer having capacity for the reduced data, storing the unreduced data in the buffer.

With reference to the Figures, wherein like numerals indicate like parts throughout the several views, a computer 205 includes a processor and a memory, and the memory stores instructions executable by the processor to perform a dimensionality reduction on unreduced data to produce reduced data, transmit the reduced data to a server 110, and, upon receiving an instruction from the server 110 responsive to the reduced data, transmit the unreduced data to the server 110. The unreduced data is time-series data generated on board the vehicle 105. The unreduced data has a plurality of unreduced dimensions at each time in a time series. The reduced data has a plurality of reduced dimensions at each time in the time series. The number of reduced dimensions is less than the number of unreduced dimensions. The server 110 is remote from the vehicle 105.

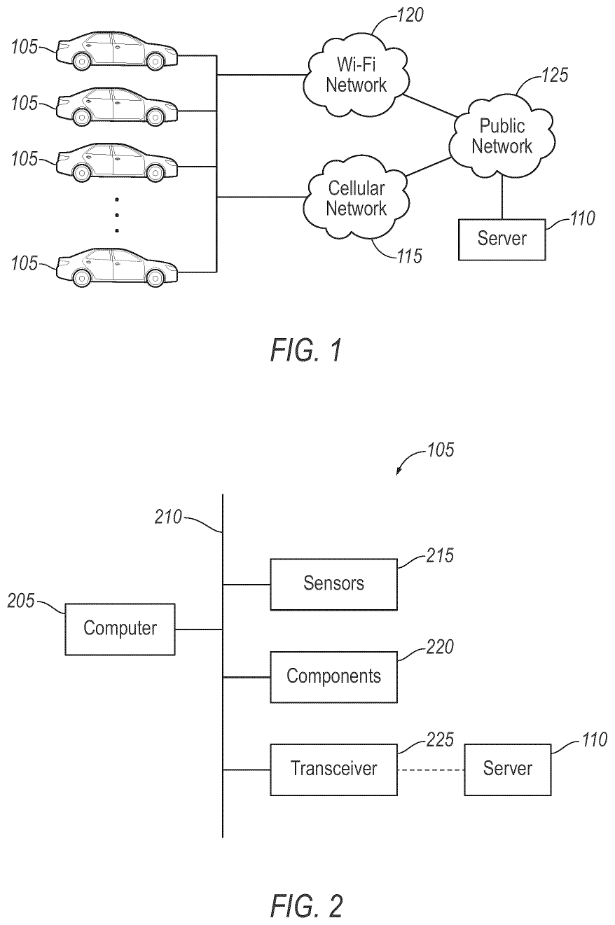

With reference to FIG. 1, a plurality of the vehicles 105 may be in communication with the server 110 at a given time. For example, the plurality of vehicles 105 can be vehicles from a common manufacturer and/or signed up for a common online service. For another example, the plurality of vehicles 105 may be part of a common fleet (e.g., of ride-hailing vehicles). The vehicles 105 may be equipped to communicate with the server 110 by connecting via a cellular network 115 and/or via a Wi-Fi network 120.

The server 110 is a microprocessor-based computing device such as a generic computing device including a processor and a memory. The memory of the server 110 can include media for storing instructions executable by the processor as well as for electronically storing data and/or databases, and/or the server 110 can include structures such as the foregoing by which programming is provided. The server 110 can be multiple computers coupled together. The server 110 may be equipped to communicate with the vehicles 105 via a public network 125.

The cellular network 115 is a wireless broadband communications network for mobile devices and other terminals. The cellular network 115 may be any wireless network complying with one or more standards promulgated by the 3rd Generation Partnership Project (3GPP) (e.g., 4G, Long-Term Evolution (LTE), 5G, 6G, etc.). The cellular network 115 may represent any of a plurality of cellular networks that the vehicle 105 may travel within range of. The vehicle 105 may be within range of the cellular network 115 in most locations to which the vehicle 105 will travel.

The Wi-Fi network 120 is a wireless communications network for mobile devices and other terminals. The Wi-Fi network 120 is a local-area network with a smaller range than the cellular network 115. The Wi-Fi network 120 may be any wireless network complying with the IEEE 802.11 family of standards. The vehicle 105 may be within range of the Wi-Fi network 120 at certain locations to which the vehicle 105 will travel (e.g., a home or workplace of the operator). The Wi-Fi network 120 may represent any of a plurality of Wi-Fi networks that the vehicle 105 may travel within range of. The Wi-Fi network 120 may provide higher bandwidth for data transmission than the cellular network 115, and the cellular network 115 may provide a more extensive aggregated range than the Wi-Fi network 120.

The public network 125 represents one or more mechanisms by which the cellular network 115 and the Wi-Fi network 120 are communicatively connected to the server 110. Accordingly, the public network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). The public network 125 may include the internet as well as facilities owned by an internet-service provider (ISP) for connecting to the internet.

With reference to FIG. 2, each vehicle 105 may be any passenger or commercial automobile such as a car, a truck, a sport utility vehicle, a crossover, a van, a minivan, a taxi, a bus, etc. The vehicle 105 may include the computer 205, an on-board network 210, sensors 215, components 220, and a transceiver 225.

The computer 205 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The computer 205 can thus include a processor, a memory, etc. The memory of the computer 205 can include media for storing instructions executable by the processor as well as for electronically storing data and/or databases, and/or the computer 205 can include structures such as the foregoing by which programming is provided. The computer 205 can be multiple computers coupled together.

The computer 205 may transmit and receive data through the on-board network 210. The on-board network 210 may be a controller area network (CAN) bus, Ethernet, Wi-Fi, Local Interconnect Network (LIN), onboard diagnostics connector (OBD-II), and/or any other wired or wireless communications network. The computer 205 may be communicatively coupled to the sensors 215, the components 220, and the transceiver 225 via the on-board network 210.

The sensors 215 may provide data about operation of the vehicle 105, for example, wheel speed, wheel orientation, and engine and transmission data (e.g., temperature, fuel consumption, etc.). The sensors 215 may detect the location and/or orientation of the vehicle 105. For example, the sensors 215 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 215 may detect the external world, including objects and/or characteristics of surroundings of the vehicle 105, such as other vehicles, road lane markings, traffic lights and/or signs, road users, etc. For example, the sensors 215 may include radar sensors, ultrasonic sensors, scanning laser range finders, light detection and ranging (lidar) devices, and image processing sensors such as cameras.

The components 220 may be actuatable to perform some task on board the vehicle 105. For example, the components 220 may be components of a propulsion system (e.g., engine, motor, drivetrain, etc.), steering system (e.g., electric power-assisted steering (EPAS) motor, etc.), user interface (e.g., touchpad, buttons, dials, microphones, speakers, etc.), suspension system (e.g., active suspension, etc.), climate-control system (e.g., heater, air conditioning, blowers, etc.), and so on.

The transceiver 225 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 225 may be adapted to communicate with a remote server, that is, a server distinct and spaced from the vehicle 105. The remote server may be located outside the vehicle 105. For example, the remote server may be associated with another vehicle (e.g., V2V communications), an infrastructure component (e.g., V2I communications), a first responder, a mobile device associated with the operator of the vehicle 105, etc. The remote server may be the server 110. The transceiver 225 may be one device or may include a separate transmitter and receiver.

With reference to FIGS. 1-2, the sensors 215 and the components 220 generate the unreduced data during operation on board the vehicle 105. For the purposes of this disclosure, “unreduced data” is defined as data to which the dimensionality reduction has not yet been applied. For example, at least a portion of the unreduced data is generated by the sensors 215 of the vehicle 105. The data generated by the sensors 215 represents what the sensors 215 detect (e.g., image data from cameras; point clouds from radar, lidar, and/or ultrasonic sensors; positions from GPS; kinematic state from IMUs; etc.). At least a portion of the unreduced data may be generated by the components 220. The unreduced data generated by the components 220 may represent the output of algorithms governing the components 220 (e.g., detections of lane lines for a lane-keeping assistance ADAS, relative motions of the wheels for a traction control system, etc.) or may represent actuations of the components 220 (e.g., RPMs for an engine, fan speed for blowers, etc.).

The unreduced data may be all or a subset of the data generated on board the vehicle 105. For example, the unreduced data may be the data generated on board the vehicle 105 that is relevant to a specific ADAS feature or multiple specific ADAS features. Advanced driver assistance systems (ADAS) are electronic technologies that assist drivers in driving and parking functions. Examples of ADAS include forward proximity detection, lane-departure detection, blind-spot detection, adaptive cruise control, and lane-keeping assistance systems. In this example, the unreduced data may include the sensor data inputted to an ADAS algorithm, the output of the ADAS algorithm, the data generated by the components 220 actuatable by the ADAS algorithm, and other sensor data describing an environment around the vehicle 105 (even if not inputted to the ADAS algorithm). For another example, the unreduced data may be all the data generated by the sensors 215 on board the vehicle 105.

The unreduced data is time-series data. As will be generally understood, and for purposes of this disclosure, time-series data are values of one or more variables at discrete successive points of time. The unreduced data may be generated at regular intervals (i.e., the times in the time-series are evenly spaced apart), for example, according to the physical characteristics of the sensor or component (e.g., a frame rate of a camera). Alternatively or additionally, the unreduced data may be generated at uneven intervals (i.e., the times in the time-series are spaced apart by different lengths of time), for example, as actuations of a component occur.

The computer 205 is programmed to receive the unreduced data. For example, the sensor and the components 220 may transmit the unreduced data over the on-board network 210 (to the computer 205 and/or to other components 220), and the computer 205 may receive the unreduced data via the on-board network 210. The sensors 215 and components 220 may transmit the unreduced data as the sensors 215 and components 220 generate the unreduced data (i.e., at each time in the time series).

The unreduced data has a plurality of unreduced dimensions at each time in the time series. For the purposes of this disclosure, a dimension of data is defined as a variable that continues to be present in the data over time, and whose value is able to vary over time. Different dimensions may follow different time series. The term “unreduced dimensions” refers to the dimensions of the unreduced data. For example, image data may have a dimension for each pixel in the image frame. The climate-control system may have a dimension for airflow direction (e.g., to the footwell, to the dashboard, to the windshield, etc.), a dimension for fan speed of the blower, a dimension for desired temperature, etc. The computer 205 may track a kinematic state of the vehicle 105 as a vector based on data from the GPS, IMUs, etc. Each value in the vector is a dimension (e.g., three spatial dimensions of position, three angular dimensions of orientation, dimensions for linear and angular velocity, etc.).

The computer 205 is programmed to perform a dimensionality reduction (described below) on the unreduced data to produce reduced data. For the purposes of this disclosure, “reduced data” is defined as data resulting from the application of the dimensionality reduction to the unreduced data. The reduced data has a plurality of reduced dimensions at each time in the time series. The term “reduced dimensions” refers to the dimensions of the reduced data. The number of reduced dimensions is less than the number of unreduced dimensions. The reduced data is thus smaller at each time of the time series than the unreduced data. The values of the reduced dimensions may be generated by the algorithm of the dimensionality reduction (as described below). The values of the reduced dimensions may not be present in the unreduced dimensions. In other words, the reduced dimensions are not a subset of the unreduced dimensions.

The computer 205 is programmed to perform the dimensionality reduction on the unreduced data to produce reduced data. The term “dimensionality reduction” is used in its conventional mathematical sense as a transformation of data from a higher-dimensional space to a lower-dimensional space such that the lower-dimensional representation retains some meaningful properties of the original data. The dimensionality reduction may take as an input the unreduced data generated at a time t or generated over a time period from t−Δt to t. The dimensionality reduction produces as an output the reduced data for the time t. The value for each of the reduced dimensions at the time t may have a contribution from multiple or all of the unreduced dimensions (e.g., may be a function of multiple or all of the unreduced dimensions). Each of the unreduced dimensions may contribute to at least one of the reduced dimensions (e.g., to multiple reduced dimensions).

The computer 205 may perform the dimensionality reduction by executing an algorithm. The algorithm may be chosen to capture the effects of the unreduced dimensions within the reduced data while still producing reduced data that is significantly smaller than the unreduced data. For example, the algorithm may be principal component analysis (PCA), a machine-learning algorithm such as an autoencoder, manifold learning, curve fitting, or any other algorithm suitable for dimensionality reduction. PCA is a linear dimensionality reduction technique that represents the unreduced data as a sequence of unit vectors, with each unit vector being orthogonal to all the preceding unit vectors. An autoencoder is an artificial neural network trained to learn an efficient coding of unlabeled data. The learned coding generates an embedding, which can be multi-modal (i.e., based on different types of data such as text, audio, images, and other types of sensor data). Manifold learning, also called nonlinear dimensionality reduction, is a transformation of higher-dimensional data onto lower-dimensional latent manifolds. Curve fitting is a process of constructing a curve or mathematical function having the best fit to a set of data. For curve fitting, the reduced dimensions may be the polynomial coefficients defining the curve. The curve fitting may be based on known statistical aggregation techniques for generating the coefficients.

The reduced dimensions are respective functions of multiple of the unreduced dimensions. In other words, each reduced dimension is a function of multiple (e.g., all) of the unreduced dimensions. The functions are defined by the operation of the algorithm used for dimensionality reduction. For example, the reduced dimensions may be a latent-space representation derived from the unreduced dimensions, with the derivation according to the algorithm for the dimensionality reduction. A latent-space representation is a representation of data in a latent space. For the purposes of this disclosure, the term “latent space” has its conventional machine-learning sense of an embedding of a set of items within a manifold in which items resembling each other are positioned closer to one another. For example, the latent-space representation may be the latent embedding produced by the autoencoder or the latent manifold produced by manifold learning.

The computer 205 is programmed to transmit the reduced data to the server 110. For example, the computer 205 may transmit the reduced data to the server 110 immediately or periodically over a short recurring period. The computer 205 may transmit the reduced data over the Wi-Fi network 120 if the vehicle 105 is within range of the Wi-Fi network 120, and the computer 205 may transmit the reduced data over the cellular network 115 if the vehicle 105 is not within range of the Wi-Fi network 120.

The server 110 may receive and store the reduced data transmitted from the vehicle 105. The server 110 may be programmed to evaluate the reduced data in order to determine whether to request the unreduced data. For example, the server 110 may determine how much data has already been collected from other vehicles 105 that is similar to the reduced data, and request the reduced data if the quantity of similar data is low. Upon determining to collect the unreduced data, the server 110 transmits an instruction responsive to the reduced data to the vehicle 105 via the public network 125.

The computer 205 transmits the unreduced data to the server 110 dependent on receiving the instruction from the server 110. The computer 205 is programmed to, upon receiving the instruction from the server 110 responsive to the reduced data, transmit the unreduced data to the server 110. Transmitting the unreduced data to the server 110 may be dependent on one or more conditions on board the vehicle 105 being satisfied, as will be described below. The computer 205 may be programmed to, in response to not receiving the instruction from the server 110 responsive to the reduced data within a time limit, refrain from transmitting the unreduced data to the server 110. The time limit may be preset in the memory of the computer 205 and may be chosen to be longer than a typical time for the reduced data to transmit to the server 110, the server 110 to evaluate the reduced data, and the instruction to transmit from the server 110 to the vehicle 105. The computer 205 may also be programmed to, in response to not receiving the instruction from the server 110 responsive to the reduced data within the time limit, delete the reduced data and/or the unreduced data.

As a general overview, the computer 205 is programmed to evaluate whether one or more conditions are satisfied to determine whether to delete the unreduced data or transmit the unreduced data to the server 110; if transmitting, whether to transmit immediately over the cellular network 115 or wait until the Wi-Fi network 120 is within range; and if waiting, whether to overwrite data in a buffer with the unreduced data or delete the unreduced data. The data already in the buffer may be previous unreduced data being replaced with new unreduced data.

The computer 205 may be programmed to receive the condition(s) from the server 110. The conditions may be chosen to indicate that the vehicle 105 has experienced an event of interest or that the reduced data reflects an unusual occurrence. The server 110 may be programmed to transmit the conditions to a plurality of the vehicles 105, for example, in response to new conditions being created. Upon receiving the conditions, the computer 205 may store the conditions in the memory of the computer 205. Receiving the conditions from the server 110 means that the conditions stored in the computer 205 on the vehicle 105 can be updated or changed over time.

Each condition may include that a prespecified event has occurred or that at least one of a set of prespecified events has occurred. The events may be occurrences on board the vehicle 105 or environmental circumstances in the vicinity of the vehicle 105. For example, the events may include an actuation of one or more components 220 (e.g., an ADAS feature engages or disengages) or a detection of something affecting the vehicle 105 (e.g., a change in kinematic state of the vehicle 105 exceeding a threshold). The events may include a metric of the reduced data exceeding a threshold. The metric may be chosen to indicate that the unreduced data is of interest. Alternatively, the metric may be chosen to indicate a difficulty of transmitting the reduced data, for example, filesize. For example, the condition may include both that one or more events has occurred and that the filesize is above or below a threshold.

The conditions may be first conditions, second conditions, or overwriting conditions. The term “first conditions” will be used herein to refer to the conditions for transmitting the unreduced data immediately rather than deleting the unreduced data or waiting for the Wi-Fi network 120 to be in range of the vehicle 105. The term “second conditions” will be used herein to refer to the conditions for transmitting the unreduced data over the Wi-Fi network 120 rather than deleting the unreduced data. The second conditions may correspond to respective first conditions. For example, at least one of the second conditions may include the same prespecified event(s) as respective first conditions but also include a maximum value on filesize or include a smaller maximum value on filesize than the respective first condition. Alternatively or additionally, at least one of the second conditions may include prespecified event(s) not included in any first conditions. (The overwriting condition is described below.)

The computer 205 is programmed to, in response to either the first condition or the second condition being satisfied, transmit the unreduced data to the server 110. The computer 205 may instruct the transceiver 225 to transmit the unreduced data over the cellular network 115 or the Wi-Fi network 120, as described below. The computer 205 may store the unreduced data in a buffer of the memory of the computer 205 for later transmission, as described below. The computer 205 is further programmed to, in response to the first condition not being satisfied and the second condition not being satisfied, delete the unreduced data.

The computer 205 is programmed to, in response to the first condition being satisfied, transmit the unreduced data to the server 110 immediately. The computer 205 may transmit the unreduced data over the Wi-Fi network 120 if the vehicle 105 is within range of the Wi-Fi network 120, and the computer 205 may transmit the unreduced data over the cellular network 115 if the vehicle 105 is not within range of the Wi-Fi network 120. The computer 205 is programmed to, in response to the first condition being satisfied and the vehicle 105 being in range of the Wi-Fi network 120, transmit the unreduced data to the server 110 via the Wi-Fi network 120. The computer 205 is programmed to, in response to the first condition being satisfied and the vehicle 105 not being in range of the Wi-Fi network 120, transmit the unreduced data to the server 110 via the cellular network 115. In other words, for the highest priority of reduced data, the computer 205 may take advantage of the higher bandwidth of the Wi-Fi network 120 if available but, if not, use the cellular network 115 to ensure that the unreduced data quickly reaches the server 110.

The computer 205 may be programmed to, in response to the second condition being satisfied (and the first condition not being satisfied), transmit the unreduced data to the server 110 via the Wi-Fi network 120 once the vehicle 105 is in range of the Wi-Fi network 120. The Wi-Fi network 120 may be used for unreduced data that is useful but less urgent or important than the unreduced data for which the first condition is satisfied. The computer 205 may store the unreduced data in the buffer of the memory until the vehicle 105 is in range of the Wi-Fi network 120.

In response to the second condition being satisfied (and the vehicle 105 being out of range of the Wi-Fi network 120), the computer 205 may either store the unreduced data in the buffer (in response to the buffer having capacity for the unreduced data), overwrite the buffer with the unreduced data (in response to the reduced data satisfying the overwriting condition), or delete the unreduced data (otherwise). The computer 205 can thus store as much of the unreduced data as possible for later transmission while still prioritizing the most useful of the unreduced data. The computer 205 may be programmed to, in response to the second condition being satisfied and the buffer having capacity for the unreduced data, store the unreduced data in the buffer. The computer 205 may be programmed to, in response to the second condition being satisfied and the buffer lacking capacity for the unreduced data, overwrite the buffer with the unreduced data in response to the reduced data satisfying the overwriting condition (described below). The data being overwritten may be previous unreduced data being replaced with new unreduced data. The computer 205 may be programmed to, in response to the second condition being satisfied and the buffer lacking capacity for the unreduced data, delete the unreduced data and retain the data in the buffer in response to the reduced data not satisfying the overwriting condition.

The overwriting condition may be that a metric calculated from the reduced data exceeds the metric calculated from data in the buffer (e.g., calculated from previous reduced data for which the unreduced data would be overwritten). The metric may be chosen to measure how unusual or atypical the reduced data are. For example, the computer 205 may calculate a mean or other statistical measure from the reduced data as the metric and then calculate a difference between the mean or other statistical measure and a prestored value. The prestored value may be a mean or other statistical measure from a larger sample of reduced data (e.g., sufficiently large to capture typical behavior). The computer 205 may perform the same calculations on the data in the buffer. If the reduced data has the larger difference, the computer 205 may overwrite the buffer, and if the data in the buffer has the larger difference, the computer 205 may delete the reduced data and retain the data in the buffer.

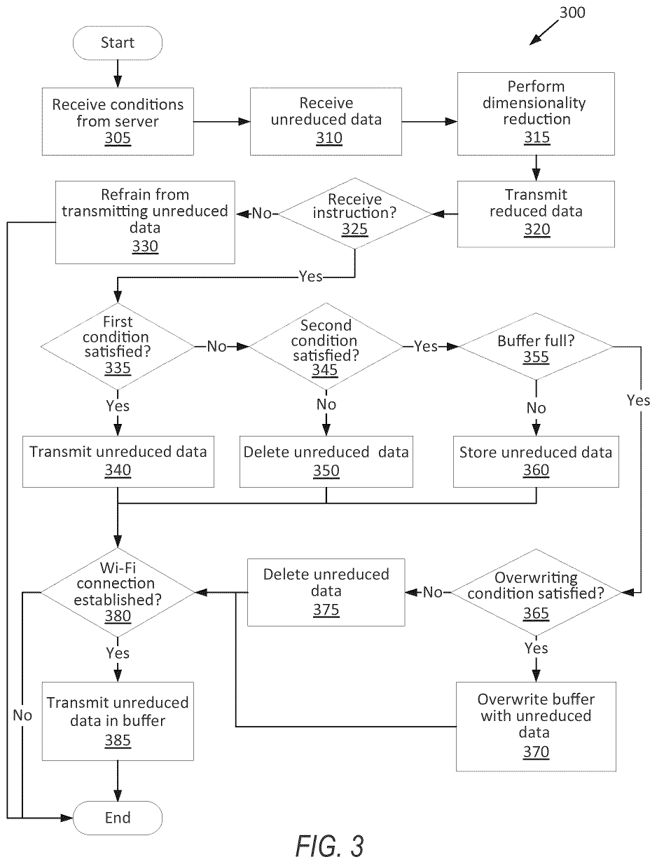

FIG. 3 is a flowchart illustrating an example process 300 for selecting data for transmission from the vehicle 105 to the server 110 and transmitting the data. The memory of the computer 205 stores executable instructions for performing the steps of the process 300 and/or programming can be implemented in structures such as mentioned above. As a general overview of the process 300, the computer 205 receives the conditions from the server 110, receives the unreduced data, performs the dimensionality reduction, and transmits the reduced data to the server 110. Dependent on receiving an instruction from the server 110, the computer 205 keeps the unreduced data for eventual transmission to the server 110 or refrains from transmitting the unreduced data to the server 110. In response to the first condition being satisfied, the computer 205 transmits the unreduced data to the server 110 immediately. Otherwise, the computer 205 evaluates the second condition. In response to the second condition not being satisfied, the computer 205 deletes the unreduced data. In response to the second condition being satisfied and the buffer having capacity, the computer 205 stores the unreduced data in the buffer. If the buffer does not have capacity, the computer 205 overwrites the buffer with the unreduced data in response to the overwriting condition being satisfied and deletes the unreduced data in response to the overwriting condition not being satisfied. In response to the vehicle 105 being within range of the Wi-Fi network 120, the computer 205 transmits the unreduced data in the buffer to the server 110.

The process 300 begins in a block 305, in which the computer 205 receives the conditions from the server 110 (e.g., the first condition, the second condition, and the overwriting condition), as described above.

Next, in a block 310, the computer 205 receives the unreduced data over the on-board network 210, as described above.

Next, in a block 315, the computer 205 performs the dimensionality reduction on the unreduced data from the block 310 to produce the reduced data, as described above.

Next, in a block 320, the computer 205 transmits the reduced data to the server 110, as described above.

Next, in a decision block 325, the computer 205 determines whether the computer 205 received an instruction from the server 110 responsive to the reduced data within the time limit, as described above. Upon receiving the instruction from the server 110 responsive to the reduced data, the process 300 proceeds to a decision block 335. In response to not receiving the instruction from the server 110 responsive to the reduced data within the time limit, the process 300 proceeds to a block 330.

In the block 330, the computer 205 refrains from transmitting the unreduced data to the server 110. After the block 330, the process 300 ends.

In the decision block 335, the computer 205 determines whether the first condition is satisfied, as described above. In response to the first condition being satisfied, the process 300 proceeds to a block 340. In response to the first condition not being satisfied, the process 300 proceeds to a decision block 345.

In the block 340, the computer 205 transmits the unreduced data from the block 310 to the server 110, either via the Wi-Fi network 120 if the vehicle 105 is in range of the Wi-Fi network 120 or via the cellular network 115 if the vehicle 105 is not in range of the Wi-Fi network 120, as described above. After the block 340, the process 300 proceeds to a decision block 380.

In the decision block 345, the computer 205 determines whether the second condition is satisfied, as described above. In response to the second condition being satisfied, the process 300 proceeds to a decision block 355. In response to the second condition not being satisfied, the process 300 proceeds to a block 350.

In the block 350, the computer 205 deletes the unreduced data from the block 310, as described above. After the block 350, the process 300 proceeds to the decision block 380.

In the decision block 355, the computer 205 determines whether the buffer has capacity for the unreduced data from the block 310, as described above. In response to the buffer having capacity for the reduced data, the process 300 proceeds to a block 360. In response to the buffer lacking capacity for the reduced data, the process 300 proceeds to a decision block 365.

In the block 360, the computer 205 stores the unreduced data from the block 310 in the buffer, as described above. After the block 360, the process 300 proceeds to the decision block 380.

In the decision block 365, the computer 205 determines whether the overwriting condition is satisfied, as described above. In response to the reduced data from the block 315 satisfying the overwriting condition, the process 300 proceeds to a block 370. In response to the reduced data not satisfying the overwriting condition, the process 300 proceeds to a block 375.

In the block 370, the computer 205 overwrites the buffer with the unreduced data from the block 310, as described above. After the block 370, the process 300 proceeds to the decision block 380.

In the block 375, the computer 205 deletes the unreduced data from the block 310, as described above. After the block 375, the process 300 proceeds to the decision block 380.

In the decision block 380, the computer 205 determines whether the vehicle 105 is within range of the Wi-Fi network 120, as described above. In response to the vehicle 105 being within range of the Wi-Fi network 120, the process 300 proceeds to a block 385. In response to the vehicle 105 being out of range of the Wi-Fi network 120, the computer 205 refrains from sending the data in the buffer, and the process 300 ends.

In the block 385, the computer 205 transmits the data stored in the buffer to the server 110. The data in the buffer may include the unreduced data from the block 310 and/or unreduced data stored in the buffer during a previous execution of the process 300. After the block 385, the process 300 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” “upon receiving,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
perform a dimensionality reduction on unreduced data to produce reduced data, the unreduced data being time-series data generated on board a vehicle, the unreduced data having a plurality of unreduced dimensions at each time in a time series, the reduced data having a plurality of reduced dimensions at each time in the time series, the number of reduced dimensions being less than the number of unreduced dimensions;
transmit the reduced data to a server remote from the vehicle; and
upon receiving an instruction from the server responsive to the reduced data, transmit the unreduced data to the server.

2. The computer of claim 1, wherein the instructions further include instructions to, in response to not receiving the instruction from the server responsive to the reduced data within a time limit, refrain from transmitting the unreduced data to the server.

3. The computer of claim 1, wherein the reduced dimensions are respective functions of multiple of the unreduced dimensions.

4. The computer of claim 1, wherein the reduced dimensions are a latent-space representation derived from the unreduced dimensions.

5. The computer of claim 1, wherein transmitting the unreduced data to the server is dependent on a condition on board the vehicle being satisfied.

6. The computer of claim 5, wherein the instructions further include instructions to, in response to the condition being satisfied and the vehicle not being in range of a Wi-Fi network, transmit the unreduced data to the server via a cellular network.

7. The computer of claim 6, wherein the condition is a first condition, and the instructions further include instructions to, in response to a second condition on board the vehicle being satisfied, transmit the unreduced data to the server via the Wi-Fi network once the vehicle is in range of the Wi-Fi network.

8. The computer of claim 7, wherein the instructions further include instructions to, in response to the first condition not being satisfied and the second condition not being satisfied, delete the unreduced data.

9. The computer of claim 6, wherein the condition is a first condition, and the instructions further include instructions to, in response to a second condition being satisfied and a buffer having capacity for the unreduced data, store the unreduced data in the buffer.

10. The computer of claim 9, wherein the instructions further include instructions to, in response to a second condition being satisfied and the buffer lacking capacity for the unreduced data, overwrite the buffer with the unreduced data in response to the reduced data satisfying an overwriting condition.

11. The computer of claim 10, wherein the overwriting condition is that a metric calculated from the reduced data exceeds the metric calculated from data in the buffer.

12. The computer of claim 5, wherein the instructions further include instructions to receive the condition from the server.

13. The computer of claim 1, wherein at least a portion of the unreduced data is generated by sensors of the vehicle.

14. The computer of claim 1, wherein the vehicle includes the computer.

15. A method comprising:
performing a dimensionality reduction on unreduced data to produce reduced data, the unreduced data being time-series data generated on board a vehicle, the unreduced data having a plurality of unreduced dimensions at each time in a time series, the reduced data having a plurality of reduced dimensions at each time in the time series, the number of reduced dimensions being less than the number of unreduced dimensions;
transmitting the reduced data to a server remote from the vehicle; and
upon receiving an instruction from the server responsive to the reduced data, transmitting the unreduced data to the server.

16. The method of claim 15, wherein the reduced dimensions are respective functions of multiple of the unreduced dimensions.

17. The method of claim 15, wherein transmitting the unreduced data to the server is dependent on a condition on board the vehicle being satisfied.

18. The method of claim 17, further comprising, in response to the condition being satisfied and the vehicle not being in range of a Wi-Fi network, transmitting the unreduced data to the server via a cellular network.

19. The method of claim 18, wherein the condition is a first condition, the method further comprising, in response to a second condition being satisfied, transmitting the unreduced data to the server via the Wi-Fi network once the vehicle is in range of the Wi-Fi network.

20. The method of claim 18, wherein the condition is a first condition, the method further comprising, in response to a second condition being satisfied and a buffer having capacity for the reduced data, storing the unreduced data in the buffer.
